(19) United States
(12) Patent Application Publication
(10) Pub. No.: US 2016/0356596 A1
(43) Pub. Date: Dec. 8, 2016

(54) APPARATUS FOR MEASURING SHAPE OF OBJECT, AND METHODS, SYSTEM, AND STORAGE MEDIUM STORING PROGRAM RELATED THERETO

(71) Applicant: CANON KABUSHIKI KAISHA, Tokyo (JP)

(72) Inventor: Tsuyoshi Kitamura, Utsunomiya-shi (JP)

(21) Appl. No.: 15/171,916

(22) Filed: Jun. 2, 2016

(30) Foreign Application Priority Data
Jun. 5, 2015 (JP) 2015-115235

(51) Int. Cl. G01B 11/25; G06T 7/60

(52) U.S. Cl. CPC G01B 11/254; G06T 7/60; G06T 2207/10004

(57) ABSTRACT

A measurement apparatus for measuring a shape of an object includes a projection unit configured to project, onto the object, pattern light including a plurality of lines on which identification portions for identifying the respective lines are arranged, an imaging unit configured to capture an image of the object having the pattern light projected thereon, and a processing unit configured to obtain information on the shape of the object based on the image, by setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.

### BACKGROUND OF THE INVENTION

Field of the Invention

Aspects of the present invention generally relate to optical profilometry, and more particularly to an apparatus for measuring the shape of an object (an object to be measured), a calculation apparatus, a calculation method, a storage medium storing a program, a system, and a method for manufacturing an article.

Description of the Related Art

As one of techniques of measuring the shape of an object, there is known an optical measurement apparatus. The optical measurement apparatus can employ various methods, which include a method called a “pattern projection method”. The pattern projection method is to find the shape of an object by projecting a predetermined pattern onto the object, capturing an image of the object having the predetermined pattern projected thereon to obtain a captured image, detecting a pattern in the captured image, and calculating distance information (range information) in each pixel position according to the principle of triangulation.

The pattern projection method can use various forms of patterns, the typical patterns of which include a pattern called a “dot line pattern”, in which breakpoints (dots) are arranged on a pattern including bright lines and dark lines alternately arranged one by one, as discussed in Japanese Patent No. 2517062. Coordinate information of each detected dot provides an index indicating which line on the pattern of a mask (the mask being a pattern generation unit) each projected line corresponds to. Therefore, the coordinate information of each detected dot enables identification of each projected line. In this way, the dots serve as identification portions used to identify the respective lines.

The measurement using a dot line pattern requires a sufficient number of dots (identification portions) to be detected in order to associate setting information on dot coordinates in a previously set pattern with information on the detected dot coordinates.

Detection of the position of each identification portion is performed based on luminance distribution (light intensity distribution) of a captured image. However, the luminance distribution of a captured image is greatly influenced by a light reflectance distribution in coordinates on the surface of an object or a light reflectance change occurring, for example, due to texture of the object. Such an influence may deteriorate the position detection accuracy for identification portions or may make it impossible to detect at least some of the identification portions. Therefore, the known techniques of measuring the shape of an object lack a high level of accuracy.

### SUMMARY OF THE INVENTION

According to an aspect of the present invention, a measurement apparatus that measures a shape of an object includes a projection unit configured to project, onto the object, pattern light including a plurality of lines on which identification portions for identifying the respective lines are arranged, an imaging unit configured to capture an image of the object having the pattern light projected thereon, and a processing unit configured to obtain information on the shape of the object based on the image, wherein the processing unit obtains the information on the shape of the object by setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a measurement apparatus according to a first exemplary embodiment.

FIG. 2 illustrates an example of a dot line pattern, which is to be projected onto an object.

FIG. 3 is a flowchart illustrating a measurement flow according to the first exemplary embodiment.

FIG. 4 illustrates an image of a projection pattern, on which imaging is performed.

FIG. 5 illustrates a luminance distribution and a luminance gradient distribution in each evaluation cross section of an image.

FIG. 6 illustrates measurement lines in an image.

FIG. 7 illustrates a luminance distribution and a luminance gradient distribution on a measurement line.

FIG. 8 illustrates feature points to be detected in each measurement line.

FIG. 9 illustrates feature points to be detected in each measurement line according to a second exemplary embodiment.

FIG. 10 illustrates a luminance distribution and a luminance gradient distribution on a measurement line according to the second exemplary embodiment.

FIG. 11 illustrates a luminance distribution of an image in a case where the duty ratio of pattern light is 1:4.

FIG. 12 illustrates a luminance distribution of an image in a case where the duty ratio of pattern light is 1:1.

FIG. 13 illustrates pattern profiles and reflectance distributions.

FIG. 14 illustrates luminance gradient distributions of the respective profiles.

FIG. 15 illustrates a comparison between shift amounts in position of the respective extremal values.

FIG. 16 illustrates a control system including a measurement apparatus and a robotic arm.

### DESCRIPTION OF THE EMBODIMENTS

Various exemplary embodiments, features, and aspects of the invention will be described in detail below with reference to the drawings.

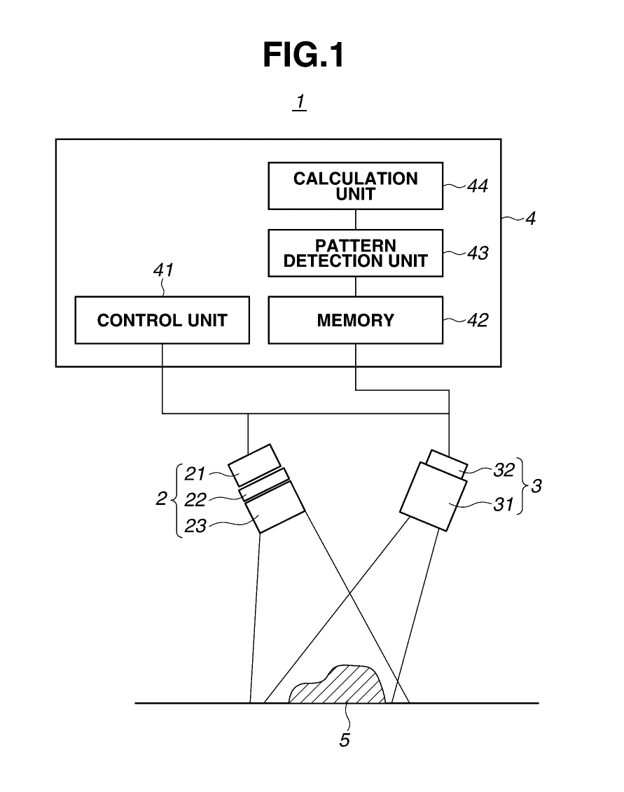

FIG. 1 is a schematic diagram illustrating a configuration of a measurement apparatus 1 according to a first exemplary embodiment. The measurement apparatus 1 measures the shape (for example, three-dimensional shape, two-dimensional shape, position, and orientation) of an object 5 (object to be measured) with the use of the pattern projection method. As illustrated in FIG. 1, the measurement apparatus 1 includes a projection unit 2, an imaging unit 3, and a processing unit 4.

The projection unit 2, which includes, for example, a light source unit 21, a pattern generation unit 22, and a projection optical system 23, projects a predetermined pattern onto the object 5. The light source unit 21 performs, for example, Kohler illumination on the pattern generation unit 22 in an even manner with light emitted from a light source. The pattern generation unit 22, which generates pattern light to be projected onto the object 5, is, in the present exemplary embodiment, composed of a mask having a pattern formed thereon by chroming a glass substrate. As used herein, chroming refers to a technique of electroplating a thin layer of chromium onto a surface of a glass substrate to form a mask having a desired pattern. However, the pattern generation unit 22 may also be composed of, for example, a digital light processing (DLP) projector, a liquid crystal projector, or a digital micromirror device (DMD), each of which is capable of generating an arbitrary pattern. The projection optical system 23 is an optical system that projects the pattern light generated by the pattern generation unit 22 onto the object 5.

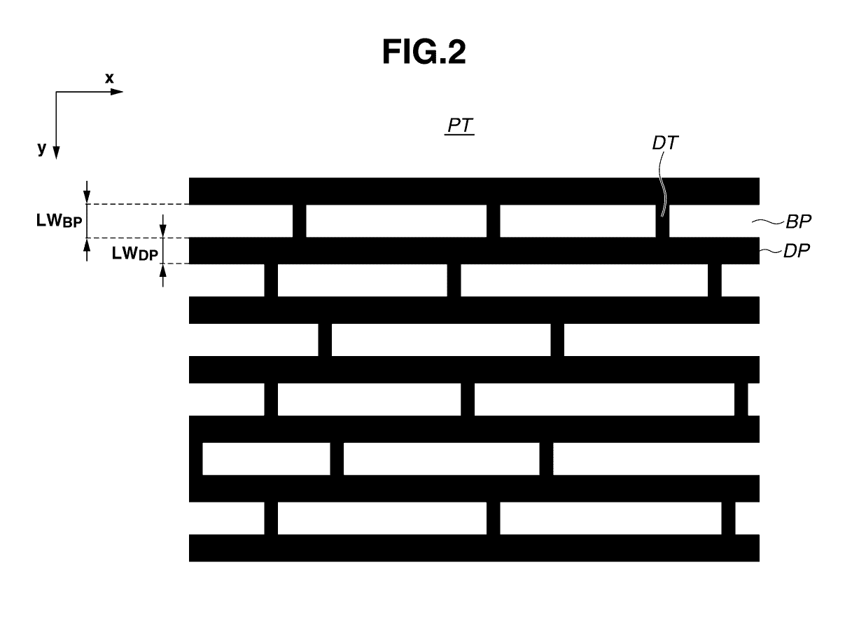

FIG. 2 illustrates a dot line pattern PT, which is an example of a pattern that is generated by the pattern generation unit 22 and is projected onto the object 5. The dot line pattern PT includes a periodical pattern including bright lines BP and dark lines DP (black) alternately arranged one by one, in which each bright line BP includes bright portions (white) and dots (dark portions) DT (black) alternately arranged one by one in one direction and each dark line DP extends in one direction. Each of the dots DT is arranged at unequal intervals between a bright portion and another bright portion in such a way as to divide a bright portion with respect to a direction (the x-direction) in which the bright portion extends on the bright line BP. The dot DT is an identification portion used to identify an individual bright line BP. Since the position of the dot DT varies with the respective bright lines BP, coordinate (position) information of the detected dot DT provides an index indicating which line on the pattern generation unit 22 each projected bright line BP corresponds to, thus enabling identifying each projected bright line BP. The ratio of the width (line width) LW_{BP} of the bright line BP to the width LW_{DP} of the dark line DP in the dot line pattern PT is arbitrary, but is 1:1 in the example illustrated in FIG. 2.

The imaging unit 3, which includes, for example, an imaging optical system 31 and an image sensor 32, performs imaging to capture an image of the object 5. In the present exemplary embodiment, the imaging unit 3 captures an image of the object 5 having the dot line pattern PT projected thereon to obtain an image including a portion corresponding to the dot line pattern PT, called a “distance image (range image)”. The imaging optical system 31 is an image forming optical system composed of, for example, a lens that forms, on the image sensor 32, an image of the dot line pattern PT projected onto the object 5. The image sensor 32, which is a sensor including a plurality of pixels used to capture an image of the object 5 having the dot line pattern PT projected thereon, is composed of, for example, a complementary metal-oxide semiconductor (CMOS) sensor or a charge-coupled device (CCD) sensor.

The processing unit 4 (a calculation apparatus) finds the shape of the object 5 based on the image acquired by the imaging unit 3. The processing unit 4 includes a control unit 41, a memory 42, a pattern detection unit 43, and a calculation unit 44. Each of the control unit 41, the pattern detection unit 43, and the calculation unit 44 is composed of, for example, a computation device, such as a central processing unit (CPU) or a field-programmable gate array (FPGA), an integrated circuit (IC), or a control circuit. The memory 42 is composed of a storage device, such as a random access memory (RAM). The control unit 41 controls operations of the projection unit 2 and the imaging unit 3, more specifically, for example, projection of the pattern on the object 5 and imaging of the object 5 having the pattern projected thereon. The memory 42 stores an image acquired by the imaging unit 3. The pattern detection unit 43 detects, using an image stored in the memory 42, peaks, edges, and dots (positions targeted for detection) of pattern light in the image to obtain the coordinates of the pattern, i.e., the position of the pattern light in the image. The calculation unit 44 calculates, using information on the positions targeted for detection (coordinates) and indexes of the respective lines identified by the dots, distance information (three-dimensional information) of the object 5 at each pixel position of the image sensor 32 according to the principle of triangulation.

The dot detection method in the present exemplary embodiment is described. The dot in the dot line pattern is a code used to identify each line number in the dot line pattern. As one of methods of associating the respective lines in the dot line pattern, there is known a method of associating break positions (dots) in lines on the captured image with the projected pattern, and the verification of association can be enhanced by verifying not only a single dot but also the consistency of a dot with surrounding dots. According to such a principle, the detection accuracy of the dot position also influences the final distance measurement accuracy. Therefore, the present exemplary embodiment is configured to more surely detect dots, thus increasing the number of detectable dots, so as to enhance the measurement accuracy. The details of such a configuration are described below.

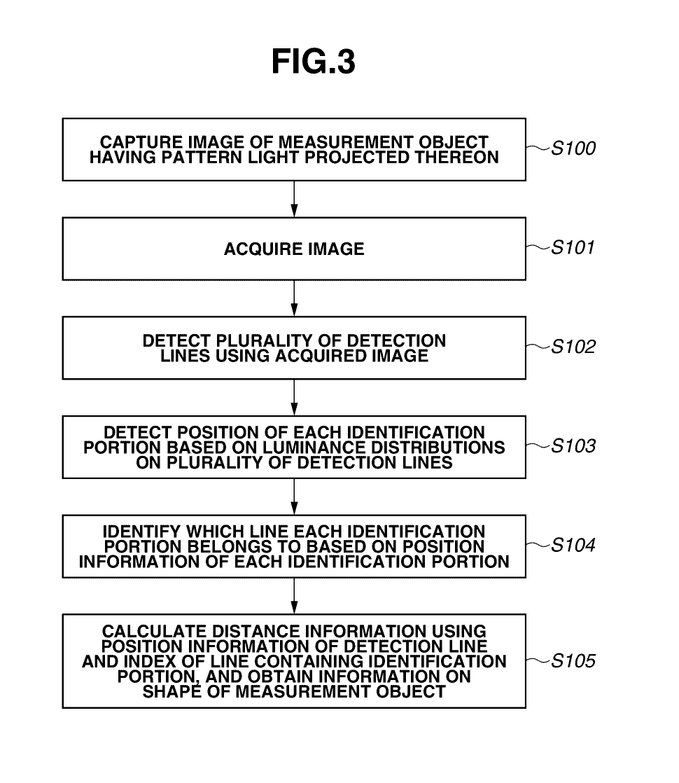

FIG. 3 illustrates a measurement flow. First, in step S100, the measurement apparatus 1 captures an image of the object having pattern light projected thereon, and stores the captured image into the memory 42. Next, in step S101, the pattern detection unit 43 of the processing unit 4 acquires the image of the object stored in the memory 42. The pattern detection unit 43 applies smoothing filter to the acquired image. This processing is performed to, in a measurement line detection process described below, reduce the difference in pixel value between a measurement line and a dot so as to prevent the measurement line from being detected in a divided manner across the dot due to the influence of any difference in pixel value between a bright line and a dot on the image.

Next, in step S102, the pattern detection unit 43 detects a measurement line (detection line) using the image subjected to the above processing. First, the pattern detection unit 43 applies Sobel filter to the image subjected to the above processing, and then calculates a luminance gradient distribution from a luminance distribution (light intensity distribution) at a cross section in a direction intersecting with bright lines of the dot line pattern PT, for example, in a direction perpendicular to the bright lines (y-direction). The luminance gradient distribution can be obtained by performing first-order differentiation on the luminance distribution with coordinates in the direction perpendicular to the bright lines.

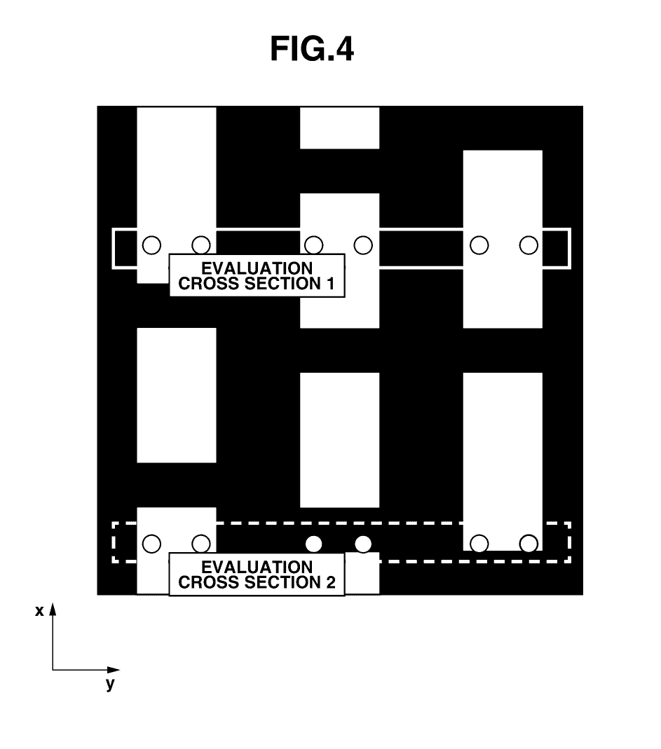

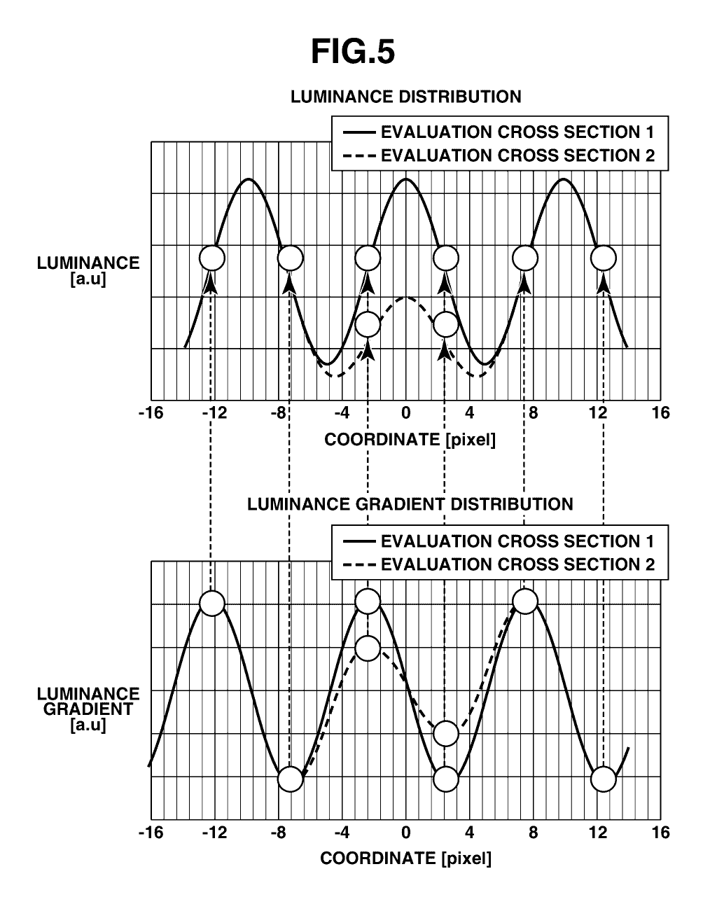

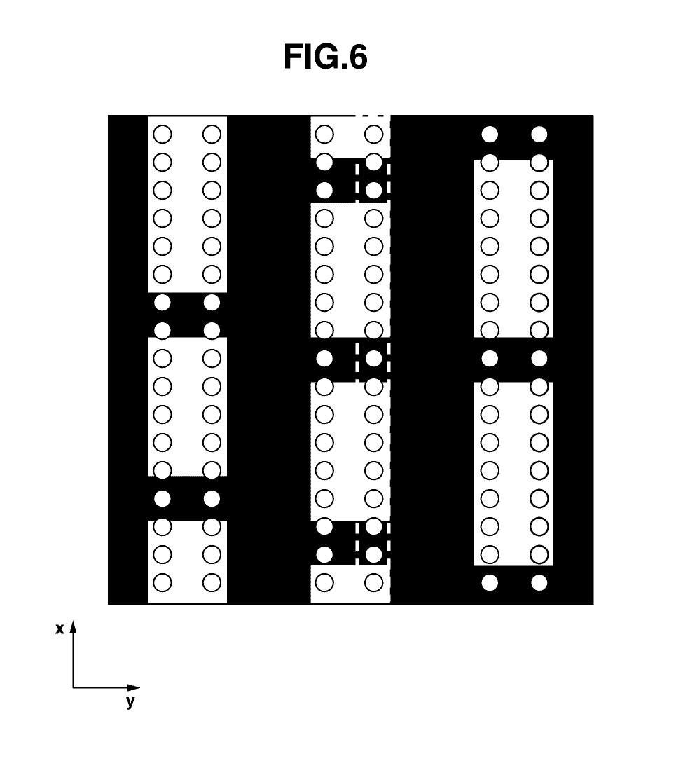

FIG. 4 is a partially enlarged view of an image including bright lines (white). FIG. 4 further illustrates evaluation cross sections 1 and 2 in the direction perpendicular to the bright lines (y-direction), at which the above-mentioned calculation is performed. The evaluation cross section 1 (indicated with a solid line) is a cross section that intersects with three bright lines, and the evaluation cross section 2 is a cross section that intersects with a bright line, a dot, and a bright line. FIG. 5 illustrates the luminance distribution and the luminance gradient distribution at each of the evaluation cross sections. The present exemplary embodiment is configured to detect coordinates at a maximal value and a minimal value (extremal values) in the luminance gradient distribution at each evaluation cross section. The detected coordinates are set as detection points. In FIGS. 4 and 5, each detection point as detected above is represented by a filled gray circle. There exist two detection points, in the direction perpendicular to the bright lines, with respect to each bright line and each dot. The pattern detection unit 43 detects the detection points in the above-described way, and is thus able to detect the position of each line of the pattern light. Furthermore, the luminance gradient distribution is calculated at each of a plurality of coordinates (pixels) in a direction parallel to the bright lines (x-direction), and a detection point at each of the plurality of coordinates is detected. FIG. 6 illustrates detection points detected at a plurality of coordinates in the direction parallel to the bright lines, each of which is represented with a filled gray circle.

As illustrated in FIG. 6, a measurement line passing through the position of a maximal value is detected by setting the positions of the respective maximal values between adjacent coordinates (pixels) in the direction parallel to the bright lines as candidate points on the same measurement line and performing labeling to connect the candidate points. With regard to the positions of minimal values, a similar operation is performed. In the present exemplary embodiment, two measurement lines are detected per each bright line. FIG. 6 also illustrates a certain measurement line with a broken line. In this way, two measurement lines are set with respect to one bright line.

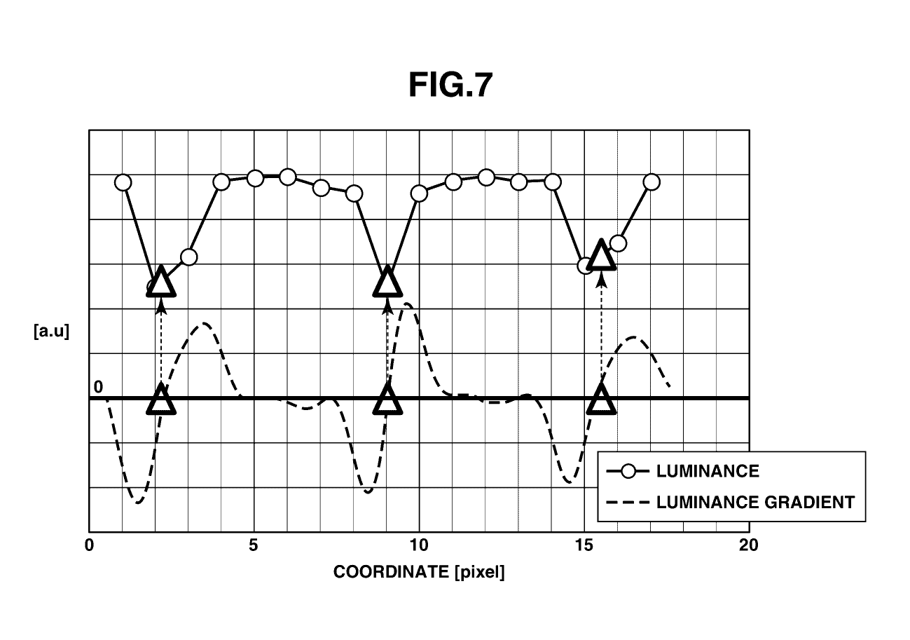

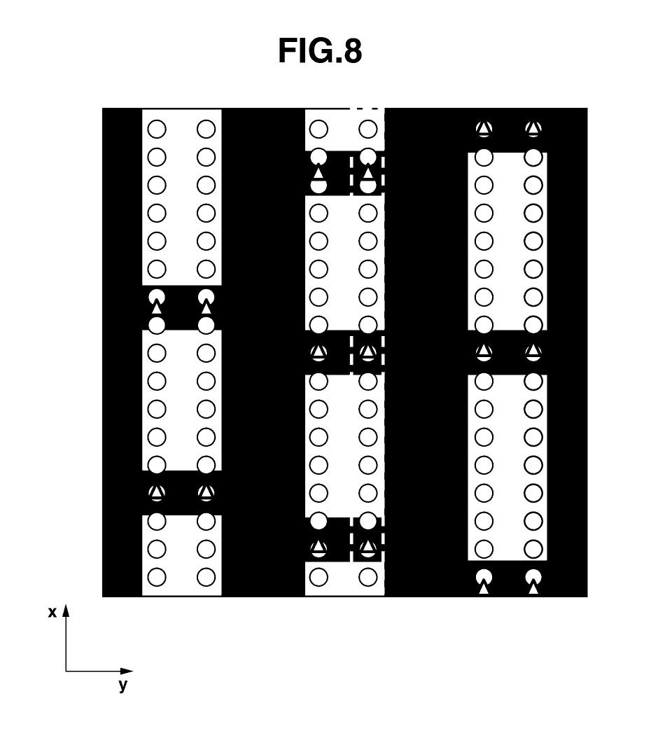

Next, in step S103, the pattern detection unit 43 detects the position of each dot (identification portion) based on luminance distributions on a plurality of detected measurement lines. FIG. 7 illustrates a luminance distribution on a measurement line (in the x-direction) and a luminance gradient distribution obtained from the luminance distribution. In the present exemplary embodiment, the luminance distribution on a measurement line has valley portions, and the coordinate detection is performed using peak positions (minimal values) of the valley portions as feature points. More specifically, a luminance gradient distribution is obtained by applying differentiation filter to the luminance distribution on a measurement line, and zero-cross points in the luminance gradient distribution are detected after applying, for example, threshold values of response intensity to the luminance gradient distribution to eliminate noise detection. FIG. 7 also illustrates the positions of zero-cross points, each of which is represented by a filled gray triangle. Moreover, FIG. 8 also illustrates the positions of zero-cross points, each of which is represented by a filled gray triangle, on the same image as that illustrated in FIG. 6. While one feature point (zero-cross point) is detected in the vicinity of one dot with respect to one measurement line, since two measurement lines are detected with respect to each bright line as mentioned above, two feature points are detected in the vicinity of one dot with respect to each bright line. Accordingly, the position (coordinates) of each dot can be determined using position information of two feature points.

In step S104, the pattern detection unit 43 identifies which bright line (number) each identification portion belongs to based on the position information of each identification portion detected in the above-described way. To perform such an identification, the pattern detection unit 43 calculates the position and inclination of an epipolar line in the coordinate system of a pattern with respect to each identification portion. Furthermore, while an epipolar plane is a plane that contains the object-side principal point of a projection lens, the image-side principal point of an imaging lens, and an object point, the epipolar line is a line of intersection of a measured image with the epipolar plane. The position and inclination of an epipolar line are calculated by projecting a straight line extending from the position of the selected identification portion in the visual line detection of the imaging lens onto the coordinate system of the projected pattern. Since the position of the selected identification portion on the coordinate system of the projected pattern is present on the epipolar line, the pattern detection unit 43 searches the pattern for a measurement line having an identification portion on the epipolar line, thus identifying which bright line the selected feature point belongs to. To perform such a search, the pattern detection unit 43 minimizes an evaluation function indicating the consistency of identification, and, on this occasion, can use a belief propagation (BP) or graph cut (GC) algorithm.

Furthermore, although, in the present exemplary embodiment, coordinates of two feature points corresponding to a maximal value and a minimal value of the luminance gradient distribution are detected with respect to one identification portion, the above identification can be performed while associating corresponding points of different identification portions with an individual feature point. Moreover, the above identification can be performed while imposing such a restraint condition that the coordinates of the above-mentioned two feature points belong to the same identification portion.

Then, in step S105, the calculation unit 44 calculates distance information of the object 5 at each pixel position of the image sensor 32 according to the principle of triangulation using coordinate information of the measurement lines detected by the pattern detection unit 43 and indexes (number) of the respective lines (bright lines) containing the respective dots identified from position information of the feature points. Then, the calculation unit 44 obtains information on the shape of the object 5 based on the distance information.

In a conventional technique, the position of one dot is determined by detecting position information of one feature point on one measurement line with respect to one dot present on one bright line. On the other hand, in the present exemplary embodiment, the position of one dot is determined by detecting position information of two feature points on two measurement lines with respect to one dot. Accordingly, the detection density of position information of a dot is improved. For example, in a case where there is an influence of a reflectance distribution or texture of an object, a large error or detection error may occur in the detected position of one feature point of the two feature points due to the mentioned influence. Even in such a case, as long as one feature point that is not influenced by texture is correctly detected, the position of a dot can be accurately detected. In other words, the existence probability of feature points that are detected can be improved. This can attain the effect of reducing the decrease of the number of identification portions that are identifiable in each line, so that the lack of a distance measurement point calculated from an image or the occurrence of a less-accurate measurement point can be reduced.

Although, in the present exemplary embodiment, a dot-shaped dark portion arranged at unequal intervals is used as an identification portion, the identification portion can have a different shape or color as long as the maximum or minimum of a luminance gradient distribution can be evaluated from the identification portion. Furthermore, the pattern that is generated by the pattern generation unit 22 and is projected onto the object 5 is not limited to a dot line pattern. For example, the pattern is not limited to bright portions and dark portions, but can be a pattern containing a plurality of lines, such as a gradation pattern or a multicolor pattern. Moreover, the line can be a straight line or a curved line. Additionally, the pattern can be a pattern obtained by reversing bright portions and dark portions of the dot line pattern illustrated in FIG. 2, in which dot-shaped bright portions are contained.

Furthermore, although, in the present exemplary embodiment, the maximum and minimum of a luminance gradient distribution at an evaluation cross section in the direction perpendicular to the bright lines are set as detection points, at least one (extremal value) of the maximum and minimum of a luminance distribution can be added to the detection points. With this configuration, for example, if the maximal point of a luminance distribution is set as a detection point, one measurement line (detection line) passing through the maximal point of the luminance distribution is obtained, so that a feature point related to each dot can be detected from the luminance distribution on the measurement line. Thus, three feature points on three measurement lines can be detected, so that the detection of the position of each dot, the identification of each line, and the measurement of distances can be more accurately performed.

Moreover, the position of the maximum or minimum may become the maximum or minimum vicinity with a certain area (width) in a luminance distribution or luminance gradient distribution. In such a case, a certain position or center position in the maximum or minimum vicinity can be selected as the position of the maximum or minimum.

As described above, according to the present exemplary embodiment, since the density of feature points used for detecting each identification portion is increased, the position of each identification portion can be more surely identified, and information on the shape of an object can be more accurately obtained. Furthermore, since the density of detection points is increased, the shape of a smaller object can also be measured.

Next, a second exemplary embodiment is described. In the second exemplary embodiment, the content of step S103 differs from that described in the first exemplary embodiment. The measurement flow except for step S103 is similar to that in the first exemplary embodiment, and the detailed description thereof is, therefore, not repeated.

In the first exemplary embodiment, in step S103, the pattern detection unit 43 sets the position of a minimal value of the luminance distribution (a zero cross point of the luminance gradient distribution) on each of a plurality of detected measurement lines as a feature point used for determining a dot position.

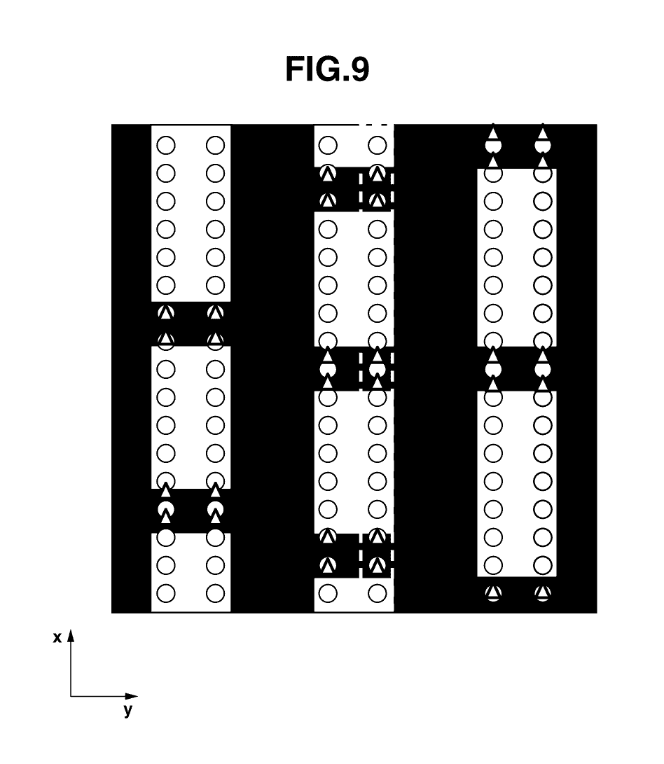

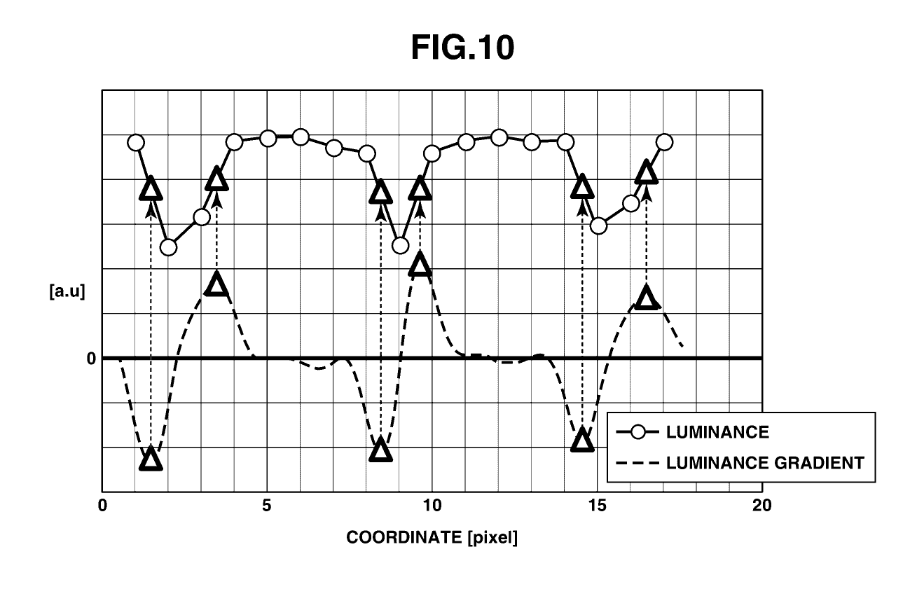

On the other hand, in the second exemplary embodiment, the pattern detection unit 43 detects, as a feature point, a maximal point or minimal point of the luminance gradient distribution on each of a plurality of detected measurement lines. More specifically, the pattern detection unit 43 detects a measurement line indicated with a broken line in FIG. 9, applies differentiation filter to a luminance distribution of the measurement line to obtain a luminance gradient distribution of the measurement line, and detects and sets the positions of a maximal value and a minimal value of the luminance gradient distribution as feature points. FIG. 10 illustrates the luminance distribution and the luminance gradient distribution on the measurement line, and also illustrates the positions of detected feature points, each of which is indicated with a filled gray triangle. FIG. 9 also illustrates the positions of detected feature points, each of which is indicated with a filled gray triangle.

Accordingly, in the luminance gradient distribution for one measurement line, two feature points for the maximal value and the minimal value are detected with respect to one dot portion. Since, similar to the first exemplary embodiment, two measurement lines are detected with respect to one bright line, the number of pieces of position information of the feature points detected from one dot portion is 4. Accordingly, since the density of feature points used for detecting each identification portion is further increased than in the first exemplary embodiment, the position of each identification portion can be more surely identified, and information on the shape of an object can be more accurately obtained.

Furthermore, for example, one measurement line (detection line) including the maximal point of the luminance distribution in the evaluation cross section perpendicular to the bright lines can be further obtained, and a feature point related to each dot can also be detected from the luminance distribution on the further obtained measurement line. Moreover, the position of a minimal value of the luminance distribution in each measurement line can also be detected as a feature point. Thus, up to nine feature points on three measurement lines can be detected, so that the detection of the position of each dot, the identification of each line, and the measurement of distances can be more accurately performed.

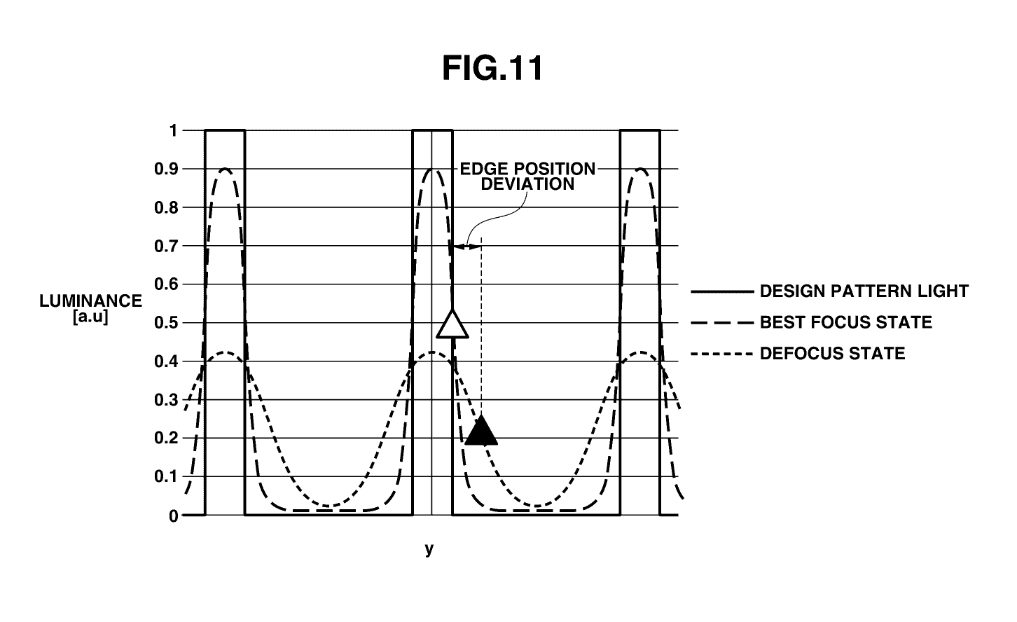

Next, a third exemplary embodiment is described. In the above-described exemplary embodiments, the duty ratio between a bright line and a dark line of the dot line pattern PT is set to 1:1, but is not necessarily 1:1. However, it is desirable that the duty ratio be 1:1 from the viewpoint of detecting edge positions. FIG. 11 illustrates design pattern light, in which the duty ratio between a bright line and a dark line is “bright line:dark line=1:4”, and luminance distributions of the measured image. The abscissa axis indicates the position in the y-direction, which is perpendicular to the direction in which each line extends, and the ordinate axis indicates luminance. The illustrated luminance distributions of the measured image include a luminance distribution obtained in a case where the measured image is captured by the image sensor in a best focus state (the position where the image is optimally in focus) and a luminance distribution obtained in a case where the measured image is captured in a defocus state (the position where the image is out of focus) in which the focus deviates 40 mm from the best focus position.

According to FIG. 11, it can be seen that an edge position (a filled triangle) obtained from the luminance distribution of an image captured in the defocus state deviates from the position (an edge position (an unfilled triangle)) of an extremal value of the luminance distribution of an image captured in the best focus state. The value obtained by converting the amount of deviation between the two edge positions into a distance calculation error is 267 μm. Therefore, it can be seen that the pattern light with a duty ratio of 1:4 causes the occurrence of a distance calculation error caused by the edge position deviation resulting from defocusing.

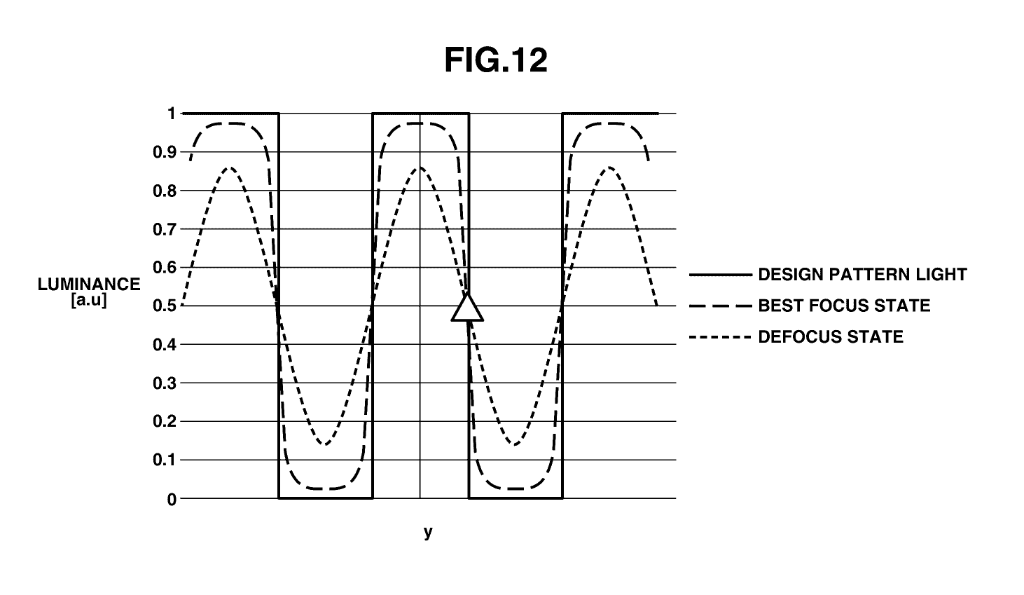

On the other hand, FIG. 12 illustrates luminance distributions obtained by the evaluation under the same condition as that in FIG. 11, with respect to pattern light with a duty ratio of 1:1 between a bright line and a dark line in the dot line pattern PT. According to FIG. 12, no deviation occurs between the edge position (an unfilled triangle) detected from a luminance distribution of an image captured in the best focus position and the edge position (an unfilled triangle) detected from a luminance distribution of the image captured in the defocus position. This is because the luminance distribution of an image captured with the illumination of pattern light with a duty ratio of 1:1 does not cause the occurrence of any positional deviation with respect to edge positions, which are peak positions, negative peak positions, and their approximate intermediate points, although contrast varies according to defocusing. Therefore, in a case where the edge position (the position of an extremal, i.e., maximal or minimal, value of the luminance gradient distribution) is used as a detection point, it is desirable that the duty ratio be close to 1:1 from the viewpoint of the influence of a positional deviation detected during defocusing.

This also applies to the case of detecting, as a feature point, the position of an extremal value of the luminance gradient distribution obtained from a luminance distribution in the direction parallel to the bright lines. More specifically, in a case where the duty ratio between a bright line and a dark line in the dot line pattern PT is set to 1:1, if an extremal value of the luminance gradient distribution in the direction parallel to the bright lines is detected as a feature point, the detection accuracy does not decrease. Accordingly, using the detected positions of such feature points enables accurately determining the position of each identification portion.

Next, a fourth exemplary embodiment is described. The detection accuracy of an extremal value of the luminance distribution and an extremal value of the luminance gradient distribution is affected by a profile (distribution) of a pattern that is projected onto an object. Herein, the profile of a pattern varies according to optical parameters, such as the numerical aperture (NA) of a projection optical system and the degree of defocus, in addition to a pattern generated by the pattern generation unit 22.

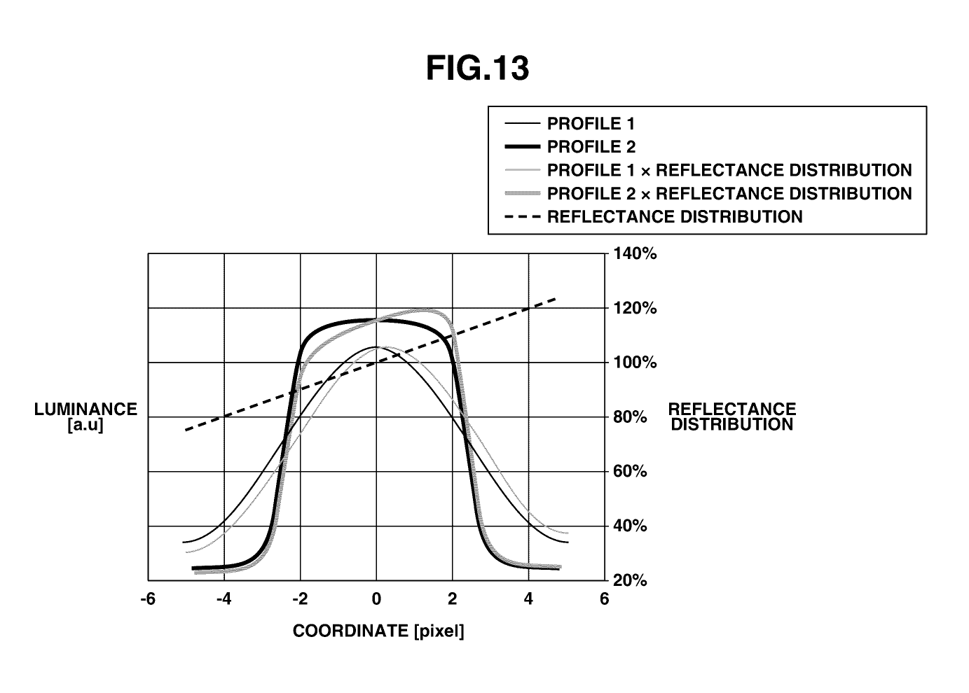

FIG. 13 illustrates, by way of example, two types of pattern profiles (a profile 1 and a profile 2) as viewed in the direction perpendicular to the bright lines. The following considers the influence of a reflectance distribution of the object on the two types of profiles. Herein, the reflectance distribution is presumed to be a linear distribution having a gradient of 5% per the range of one pixel on an image. FIG. 13 illustrates the reflectance distribution with a broken line. The reflectance distribution indicates relative values based on 100% set at the coordinate “0”. The luminance distribution on an image is obtained by multiplying each pattern profile by the reflectance distribution (profile×reflectance distribution), as illustrated in FIG. 13.

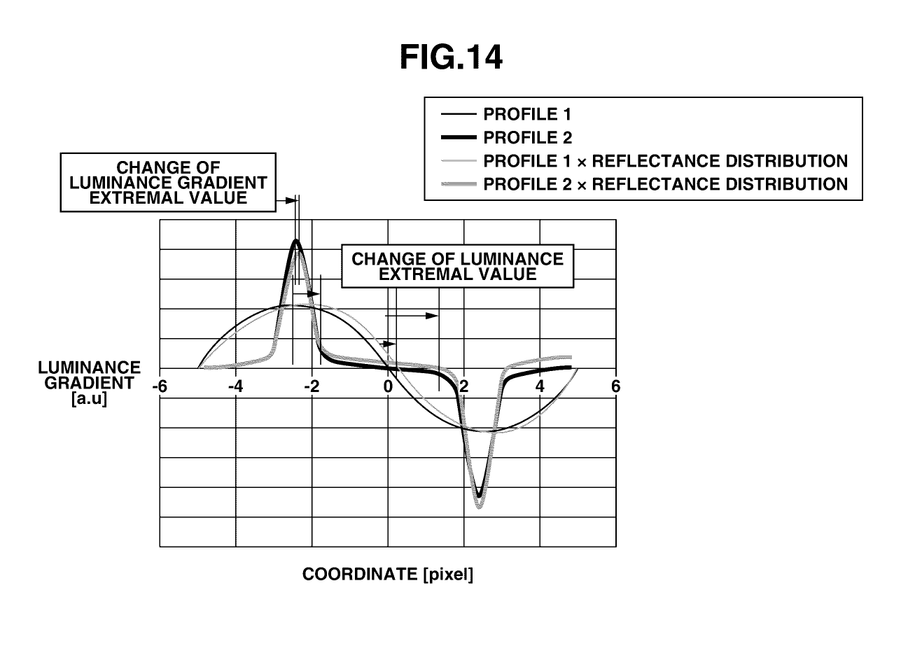

FIG. 14 illustrates luminance gradient distributions obtained with respect to the luminance distributions illustrated in FIG. 13. Thus, FIG. 14 clarifies the amount of shift (deviation) of each of the position of an extremal value of the luminance and the position of an extremal value of the luminance gradient between a case where there is a reflectance distribution and a case where there is no reflectance distribution with respect to each profile.

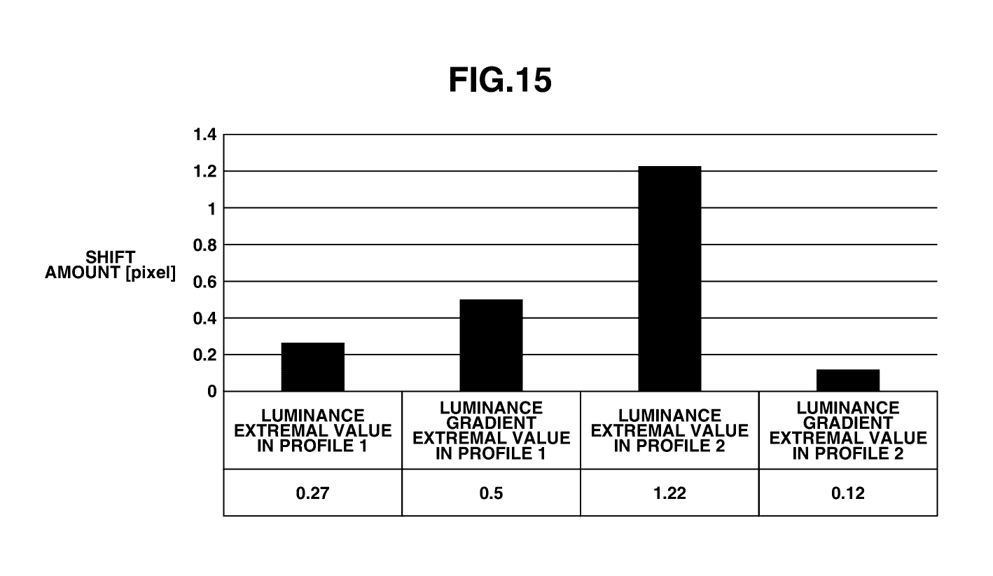

FIG. 15 illustrates in a bar graph the amounts of shift of the above-mentioned positions. With regard to the profile 1, while the amount of shift of the position of an extremal value of the luminance gradient is 0.5 pixel, the amount of shift of the position of an extremal value of the luminance is 0.27 pixel. Thus, the amount of shift regarding the reflectance distribution is larger in the position of an extremal value of the luminance gradient than in the position of an extremal value of the luminance. On the other hand, with regard to the profile 2, while the amount of shift of the position of an extremal value of the luminance gradient is 0.12 pixel, the amount of shift of the position of an extremal value of the luminance is 1.22 pixel. In other words, the amount of shift of each of the position of an extremal value of the luminance and the position of an extremal value of the luminance gradient regarding the reflectance distribution varies with pattern profiles to be projected onto an object.

In view of such a result, the position detection accuracy can be effectively improved by performing weighting on the detection results (detected positions) of an extremal value of the luminance and an extremal value of the luminance gradient based on the pattern profiles or their determination factors. For example, in the case of an optical condition in which the spread of a point spread function (PSF) is large (for example, the profile 1), it is estimated that the position detection accuracy of an extremal value of the luminance gradient is lower than the position detection accuracy of an extremal value of the luminance. In such a case, when identifying an identification portion, the pattern detection unit 43 performs weighting while setting a weight added to the detected position of an extremal value of the luminance gradient smaller than a weight added to the detected position of an extremal value of the luminance. This enables increasing the number of detected feature points while maintaining the effective position detection accuracy.

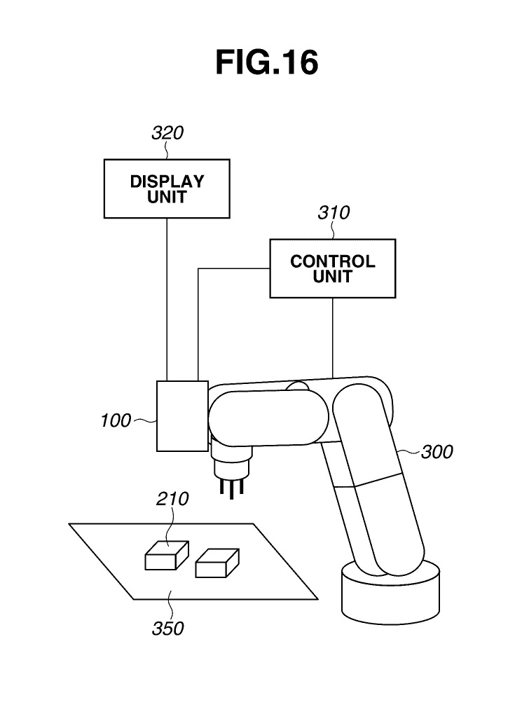

The above-described measurement apparatus can be used while being supported by a certain supporting member. In a fifth exemplary embodiment, by way of example, a control system that is used while being mounted on a robotic arm 300 (a gripping device), as illustrated in FIG. 16, is described. A measurement apparatus 100 projects pattern light onto a test object 210 placed on a support base 350 and captures an image of the test object 210 having the pattern light projected thereon to generate image data. Then, a control unit of the measurement apparatus 100 or a control unit 310, which has acquired the image data from the control unit of the measurement apparatus 100, obtains the position and orientation of the test object 210 based on the image data, and the control unit 310 acquires information on the acquired position and orientation. The control unit 310 sends, based on the information on the acquired position and orientation, a drive command to the robotic arm 300 to control the robotic arm 300. The robotic arm 300 holds the test object 210 with, for example, a robotic hand (gripping portion) mounted at the tip thereof, and moves, such as translates or rotates, the test object 210. Furthermore, the control system can assemble the test object 210 to another component using the robotic arm 300 so as to manufacture an article 220 composed of a plurality of components, for example, an electronic circuit board or a machine. Moreover, the control system can process the moved test object 210 to manufacture an article. The control unit 310 includes a computation device, such as a central processing unit (CPU), and a storage device, such as a memory (not shown). Additionally, a control unit that controls a robot, such as the robotic arm 300, can be provided outside the control unit 310. Furthermore, the control system can display measurement data measured by the measurement apparatus 100 or the acquired image on a display unit 320, such as a display.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

Although various exemplary embodiments of the present invention have been described above, the invention is not limited to such exemplary embodiments, but can be modified or altered in various manners within the scope of the spirit of the invention. According to the invention, a pattern projection method using pattern light including a plurality of lines on which identification portions for identifying the respective lines are arranged can be used to detect each identification portion at higher accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-115235 filed Jun. 5, 2015, which is hereby incorporated by reference herein in its entirety.

What is claimed is:

1. A measurement apparatus that measures a shape of an object, comprising:
a projection unit configured to project, onto the object, pattern light including a plurality of lines on which identification portions for identifying the respective lines are arranged;
an imaging unit configured to capture an image of the object having the pattern light projected thereon; and
a processing unit configured to obtain information on the shape of the object based on the image,
wherein the processing unit obtains the information on the shape of the object by setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.

2. The measurement apparatus according to claim 1, wherein the plurality of detection lines includes a detection line passing through a position where a luminance gradient obtained from the luminance distribution of the image in the direction intersecting with the plurality of lines becomes maximal, and a detection line passing through a position where the luminance gradient becomes minimal.

3. The measurement apparatus according to claim 1, wherein the plurality of detection lines includes a detection line passing through a position where a luminance gradient obtained from the luminance distribution of the image in the direction intersecting with the plurality of lines becomes an extremal value, and a detection line passing through a position where a luminance becomes an extremal value in the luminance distribution of the image in the direction intersecting with the plurality of lines.

4. The measurement apparatus according to claim 1, wherein the processing unit detects a first position where a luminance gradient obtained from the luminance distribution of the image in the plurality of lines becomes maximal and a second position where a luminance gradient obtained from the luminance distribution of the image in the plurality of lines becomes minimal, and detects the position of the identification portion based on the detected first and second positions.

5. The measurement apparatus according to claim 1, wherein the processing unit detects a first position where a luminance gradient obtained from the luminance distribution of the image in the plurality of lines becomes an extremal value and a second position where a luminance becomes an extremal value in the luminance distribution of the image in the plurality of lines, and detects the position of the identification portion based on the detected first and second positions.

6. The measurement apparatus according to claim 4, wherein the processing unit performs weighting on a plurality of positions detected in the plurality of detection lines, and detects the position of the identification portion based on a result of the performed weighting.

7. The measurement apparatus according to claim 1, wherein the pattern light includes bright lines and dark lines alternately arranged one by one, and
wherein the identification portion is an identification portion used for identifying the bright line or the dark line.

8. A calculation apparatus that calculates a shape of an object, the calculation apparatus comprising:
a processing unit configured to capture an image of the object on which pattern light including a plurality of lines on which identification portions for identifying the respective lines are arranged has been projected, and configured to obtain information on the shape of the object based on the image,
wherein the processing unit obtains the information on the shape of the object by setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.

9. A method for calculating a shape of an object, comprising:
processing an image of the object on which pattern light including a plurality of lines on which identification portions for identifying the respective lines are arranged has been projected; and
obtaining information on the shape of the object based on the image,
wherein obtaining the information on the shape of the object includes setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.

10. A non-transitory storage medium storing a program that causes an information processing apparatus to perform the calculation method according to claim 9.

11. A system comprising:
a measurement apparatus that measures a shape of an object; and
a robot configured to hold and move the object based on a result of measurement by the measurement apparatus,
wherein the measurement apparatus comprising:
a projection unit configured to project, onto the object, pattern light including a plurality of lines on which identification portions for identifying the respective lines are arranged;
an imaging unit configured to capture an image of the object having the pattern light projected thereon; and
a processing unit configured to obtain information on the shape of the object based on the image, and
wherein the processing unit obtains the information on the shape of the object by setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.

12. A method for manufacturing an article, the method comprising:
measuring an object using a measurement apparatus; and
manufacturing the article by processing the object based on the measurement result,
wherein the measurement apparatus measures a shape of the object, the measurement apparatus comprising:
a projection unit configured to project, onto the object, pattern light including a plurality of lines on which identification portions for identifying the respective lines are arranged;
an imaging unit configured to capture an image of the object having the pattern light projected thereon; and
a processing unit configured to obtain information on the shape of the object based on the image, and
wherein the processing unit obtains the information on the shape of the object by setting a plurality of detection lines in one line of the plurality of lines based on a luminance distribution of the image in a direction intersecting with the plurality of lines, detecting a position of the identification portion based on a luminance distribution of the image in the plurality of detection lines, and identifying the respective plurality of lines using the detected position of the identification portion.
